(19) United States
(12) Patent Application Publication
(10) Pub. No.: US 2012/0102073 A1
(43) Pub. Date: Apr. 26, 2012

(54) CONTEXTUAL PRESENCE SYSTEM AND ASSOCIATED METHODS

(76) Inventor: Yogesh B. Patel, Mountain View, CA (US)

(21) Appl. No.: 13/279,896

(22) Filed: Oct. 24, 2011

Related U.S. Application Data
(60) Provisional application No. 61/405,967, filed on Oct. 22, 2010.

(51) Int. Cl. G06F 17/30

(52) U.S. Cl. 707/803; 707/E17.044; 707/E17.032

(57) ABSTRACT

Systems and methods dynamically form a context group that has a plurality of members and propagate payload data between the members. A database associates a context identifier (ID) of the context group with a user ID of each member. A context manager, communicatively coupled with the database, receives a join context request containing the context ID and a user ID from each said member, creates the context group, if not existing, within the database in response to the join request, and adds the user ID, if not existing, of each said member to the database in association with the context ID. A payload handler receives payload data from one of said members and propagates the payload data to other said members of the context group.

### RELATED APPLICATIONS

This application claims priority to U.S. Patent Application Ser. No. 61/405,967 titled “Contextual Presence System and Associated Methods”, filed Oct. 22, 2010, and incorporated herein by reference.

### BACKGROUND

A presence system collects real-time presence information about an individual, applies one or more rules that deduce a status of that individual from that information, and then publishes that information to one or more acquaintances of that individual (known as watchers). Although the presence information is typically ascribed to an individual, the presence information is typically received from devices associated with that individual. For example, a computer associated with (and used by) the individual may send a message to the presence system indicating that it is being used by the individual. The presence system thereby implies that the individual is proximate to that computer when the computer indicates it has user interaction.

Presence systems can be based on an Instant Messaging like paradigm where there is typically a single context (for example, logged in or online with a device) and the people who can see each other's presence in that single context are previously known to each other as part of their buddy list system.

Presence systems can also be based on gaming/chat rooms where there is a fixed set of contexts (e.g., a game room or a chat room) and people that join those contexts can see each other. These contexts typically stay for a long period and people can remain anonymous.

Typically, a presence server written for one of the paradigms above cannot be used practically for the other.

FIG. 1 shows one prior art presence system 100. A presence server 102 of system 100 receives presence information 122 relating to an individual 110 from at least one source, such as a device 104 used by individual 110. Individual 110 subscribes to services of presence server 102 and provides rules as to how presence information 122 is handled and published by presence server 102. In FIG. 1, acquaintances 112 and 114 of individual 110 also subscribe to presence server 102 and are authorized by individual 110 to receive published presence information 124 associated with individual 110 (and based upon presence information 122). Specifically, acquaintance 112 utilizes a watcher device 106(1) to receive presence information 124(A) from presence server 102, and acquaintance 114 utilizes a watcher device 106(2) to receive presence information 124(B) from presence server 102. Devices 104 and 106 may represent a device selected from the group including: mobile phones, personal digital assistants (PDAs), smart phones, and personal computers.

In operation, device 104 allows individual 110 to send presence information 122 (such as a current location, and an activity such as working) to presence server 102, which in turn publishes (i.e., sends) presence information 124 to acquaintances 112 and 114, thereby informing them of changes in the status of individual 110. Specifically, devices 106(1) and 106(2) do not request status information 124(A) and 124(B), respectively, from presence server 102, but are notified directly upon changes to the stored presence of individual 110.

Where device 104 represents a mobile phone, an associated service provider (or the phone itself if it includes GPS functionality) may determine a location of device 104 automatically and send this location as presence information 122 to presence server 102. Thus, published presence information 124 may include location information of device 104, which is also assumed to be the location of individual 110.

Presence server 102 may represent similar social networking services, such as Facebook™, where individual 110 describes current activities and feelings for publication to a network of authorized ‘friends’. Presence server 102 may also represent more than one presence server and social networking server that interact to receive and publish presence information.

In conventional presence systems, such as shown in FIG. 1, when presence status of an individual changes, presence information is published only to authorized subscribers (i.e., acquaintances of the individual) of that information. Scalability of conventional presence is poor: the more subscribers to an individual's presence information, the more work is required to publish that information. Presence information of an individual cannot be received without subscribing to that information through the presence server, and being authorized by the individual to receive that information. Presence information is not available to a third party unknown to the individual.

Further, since there are many difference presence systems, certain acquaintances of the individual may subscribe to a different presence system that the one subscribed to by the individual. Often, to overcome this limitation, the individual would subscribe to more than one presence system such that acquaintances would be allowed to receive published presence information from the individual.

### SUMMARY OF THE INVENTION

In an embodiment, a contextual presence system (CPS) dynamically forms a context group having a plurality of members and propagates payload data between the members. The system includes a database for associating a context identifier (ID) of the context group with a user ID of each said member, a context manager, communicatively coupled with the database, and a payload handler for receiving payload data from one of said members and for propagating the payload data to other said members of the context group. The context manager receives a join context request containing the context ID and a user ID from each said member, creates the context group, if not existing, within the database in response to the join request, and adds the user ID, if not existing, of each said member to the database in association with the context ID.

In another embodiment, a computer implemented method dynamically forms a context group. A first join context request is received from a first user device running an application and includes (a) a context ID defined by the application and (b) a first user ID of the first user device. The context group is created within a database based upon the context ID and the first user ID directly upon receiving the first join context request.

### BRIEF DESCRIPTION OF THE FIGURES

FIG. 1 shows a presence system of the prior art.

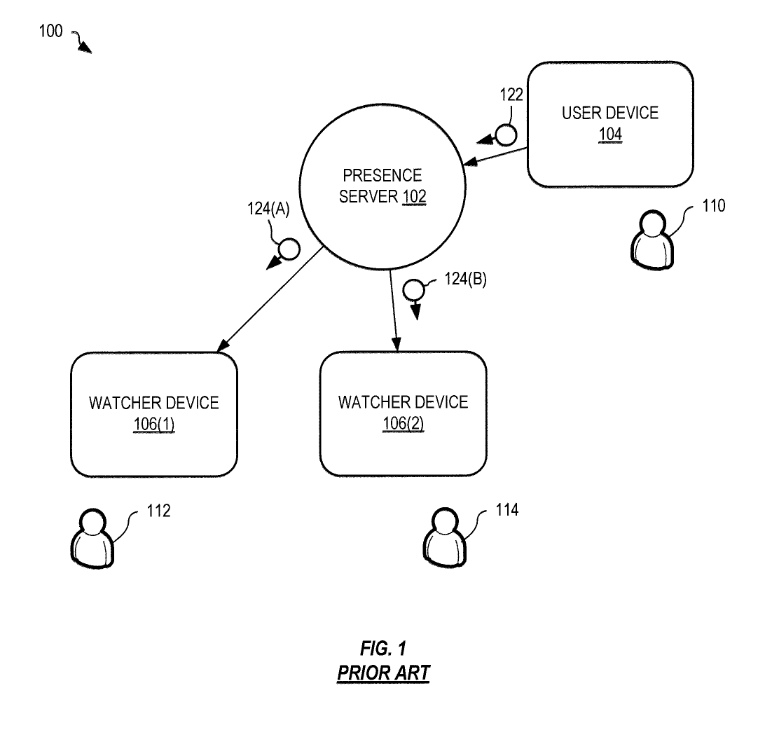

FIG. 2 shows one exemplary contextual presence system for providing ad hoc on-the-fly contextual presence, in an embodiment.

FIG. 3 is a flowchart illustrating one exemplary method for interacting with the contextual presence server (CPS) of FIG. 2 from an application running on a user device, in an embodiment.

FIG. 4 is a flowchart illustrating one exemplary method for creating and managing a context group, in an embodiment.

FIG. 5 is a flowchart illustrating one exemplary method for handling payload, in an embodiment.

FIG. 6 shows the payload handler of FIG. 2 with a plurality of edge nodes, in an embodiment.

FIG. 7 shows the CPS of FIG. 2 connected to two application servers, each having a plurality of clients, in an embodiment.

### DETAILED DESCRIPTION OF THE DRAWINGS

Unlike prior art presence systems that publish presence information to registered watchers of that information, a contextual presence system transports payload data between members of a context group, where that context group may be created in real-time as needed. Scalability of the contextual presence system is superior in that payload data is not collected and propagated to a list of specific watchers, as occurs in the prior art.

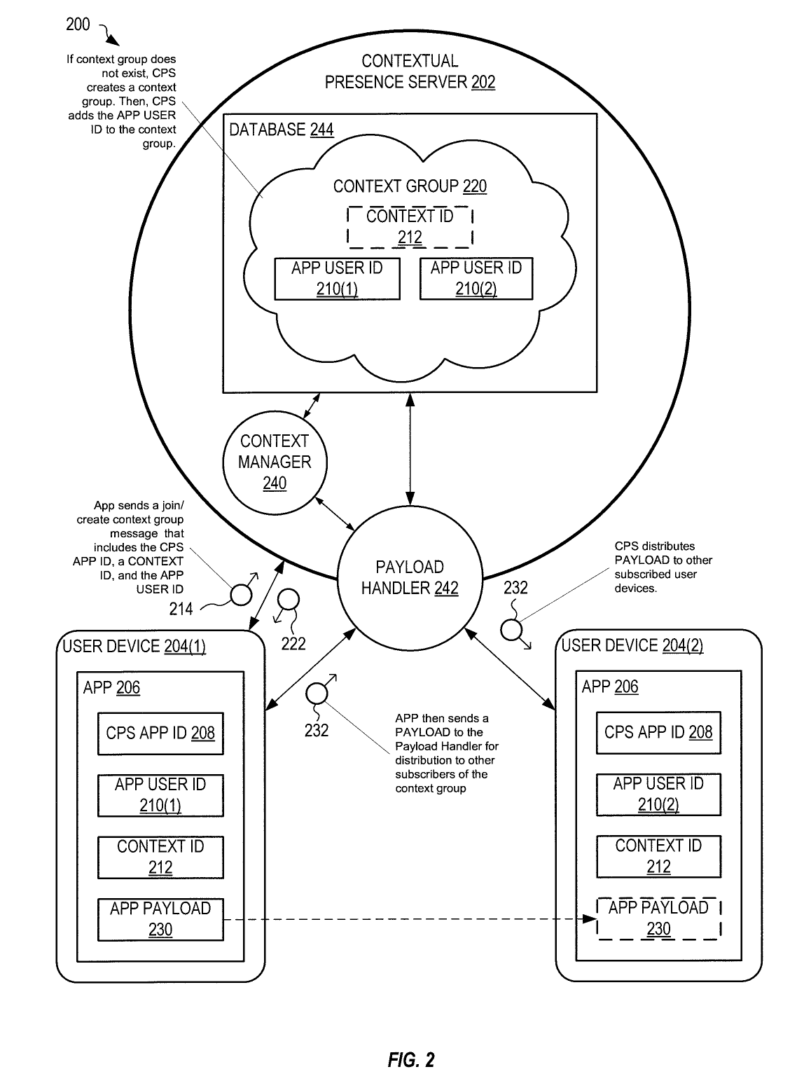

FIG. 2 shows one exemplary contextual presence system 200 for providing ad-hoc, on-the-fly, contextual presence. System 200 includes a contextual presence server (CPS) 202 that interacts with at least one user device 204. CPS 202 includes a database 244, a context manager 240 communicatively coupled with database 244 for managing context groups within database 244, and a payload handler 242 for propagating application payload 230, received from a member of a particular context group, to other members of that context group. Context manager 240, payload handler 242, and database 244 are for example software applications that are executed by a processor of CPS 202. A context group member is for example a user of an application 206 running on a computing device of the user, for example.

Continuing with the example of FIG. 2, CPS 202 is shown interacting with user devices 204(1) and 204(2). User devices 204 may represent any device or devices capable of communicating within system 200, such as one or more of: a smart phone, a tablet computer, a laptop computer, and a desktop computer. That is, user device 204 includes a memory for storing data and machine readable instruction and a processor for executing these instructions and processing the data. Each user device 204 includes an application 206 that is for example downloaded into user device 204 from an application store. Application 206 is preconfigured with a CPS application ID 208 that may be unique, such that CPS 202 may distinguish application 206 from other applications that may be in communication with CPS 202. That is, CPS application ID 208 allows application 206 to utilize services of CPS 202. Further, CPS application ID 208 may also allow CPS 202 to validate received communication as being from an authentic source.

Within user device 204, application 206 utilizes an application user ID 210 that identifies the specific user of application 206 on user device 204. In the example of FIG. 2, application 206 running on user device 204(1) utilizes an application user id 210(1) and application 206 running on user device 204(2) utilizes an application user ID 210(2). That is, although each user device 204 may run the same application 206, communication from these applications may be distinguished by CPS 202 based upon application user ID 210.

Application 206 interacts with CPS 202 to create context group 220 based upon a user's operation of application 206 running on user device 204. Application 206 creates a context ID 212, which may be based upon functionality of application 206. For example, where application 206 is a crossword application that presents the user of device 204 with one of a plurality of crosswords to solve, context ID 212 may be based upon, at least in part, that particular crossword. Thus, where the application is running on a second user device 204(2) and is presenting the same crossword to a second user, that user may automatically join the same context group 220. When the user finishes the crossword and selects another or simply leaves application 206, their application user ID 210 is automatically removed from context group 220. In another example, where application 206 is a game, context ID 212 may be based upon the current user's level within that game, such that the user may be aware of other players at that level. In another example, where application 206 is a conferencing application, context ID 212 may be selected from a list of active conferences, thereby allowing the user to register with the context group associated with a particular conference. In one embodiment, context ID 212 is predefined within application 206.

Application 206 may also utilize an application user ID 210 that is unique within context group 220 and associated with the user of application 206 on that user device 204. Application user ID 210 is then used to register the user of user device 204 within context group 220. As shown in FIG. 2, application user ID 210(1) of user device 204(1) and application user ID 210(2) of user device 204(2) are both registered with context group 220, which is identified by context ID 212.

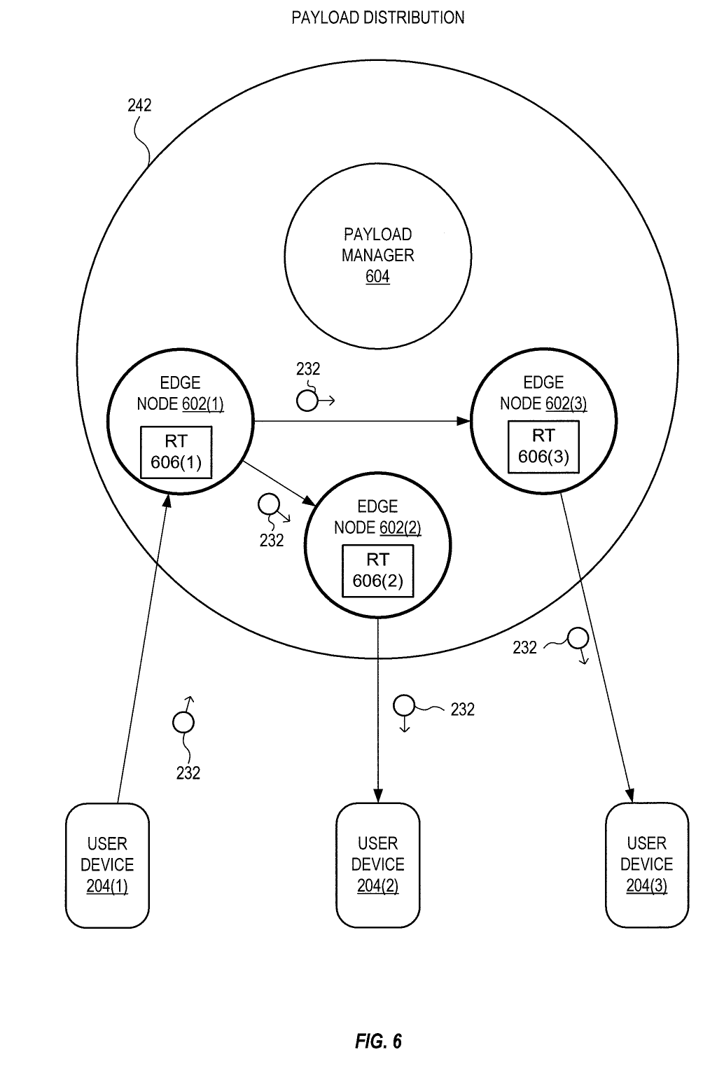

Also associated with application 206 and context group 220 is an application payload 230. Neither CPS 202 nor context group 220 defines the size or content of application payload 230; rather, application 206 defines the size and content of application payload 230. In one example of operation, application payload 230 is propagated by a payload handler 242 to other members (e.g., application 206 of user device 204(2) that is associated with application user ID 210(2)) of context group 220. Application payload 230 is not necessarily sent to CPS 202, but is preferably handled by edge nodes (see FIG. 6 and associated description) that are managed by payload handler 242.

CPS 202 includes a context manager 240 for interacting with each application 206 to construct, manage, and destroy context group 220. CPS 202 also includes a payload handler 242 that propagates received application payloads 230 to other members of the context group to which the sending application belongs.

CPS 202 does not specifically identify individuals within each context group. That is, identity of context group members is handled by each application 206. It should also be noted that context groups 220 and applications 206 do not rely upon the concept of “buddy” lists. Application payloads 230 are propagated to all other members of a context group, whether they are known to one another, or not. In the above example where application 206 presents a crossword puzzle, many users may be running application 206 simultaneously. Of those users, many may be working on the same crossword, and thereby are members of the same context group. Unlike conventional presence servers where presence information of a user is propagated only to subscribed watchers of that presence information, CPS 202 propagates payload data (which may include a status of a user) to each other member of the context group. Context group 220 and its associated application payload 230 propagation may therefore be very large in comparison to the number of watchers in prior art presence that have limited authorized watchers.

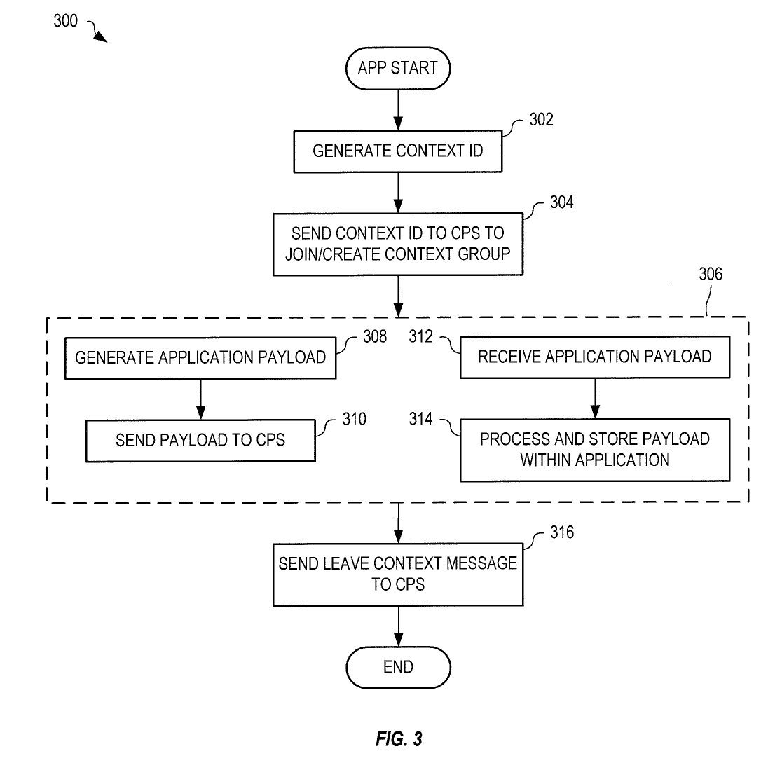

FIG. 3 is a flowchart illustrating one exemplary method 300 for utilizing CPS 202 of FIG. 2 from an application 206 running on a user device 204. Method 300 is implemented as machine readable instructions loaded within a memory of user device 204 as at least part of application 206, for example. In step 302, a context ID is generated. In one example of step 302, application 206 runs within user device 204(1) and generates a context ID based upon functionality of application 204(1). In step 304, a message containing a CPS application ID and the generated context ID of step 302 is sent to the CPS. In one example of step 304, application 206 running on user device 204(1) sends a message 214 including CPS application ID 208, context ID 212, and application user ID 210(1) to CPS 202.

Dashed outline 306 represents a portion of method 300 in which application 206 interacts with CPS 202 to distribute a payload to other members of the context group, and in which application 206 receives a payload from other members of the context group. In step 308, the application generates a payload for distribution to other members of the context group. In one example of step 308, application 206 generates application payload 230 based upon the user's progress with a displayed crossword. In step 310, the application sends the payload of step 308 to the CPS. In one example of step 310, application 206 sends a message including CPS application ID 208, context ID 212, application user ID 210(1), and application payload 230 to CPS 202. Steps 308 and 310 repeat based upon functionality of application 206. For example, the application 206 may repeat steps to 308 and 310 each time the user changes the status of application 206. In step 312, application receives the payload from CPS 202. In one example of step 312, application 206 receives application payload 230. In step 314, the application processes and stores the payload received in step 312. In one example of step 314, application 206 processes and stores application payload 230. Steps 312 and 314 repeat for each payload received from CPS 202.

In step 316, the application that sends a message to the CPS to leave the context group. In one example of step 316, application 206 sends an exit message to CPS 202.

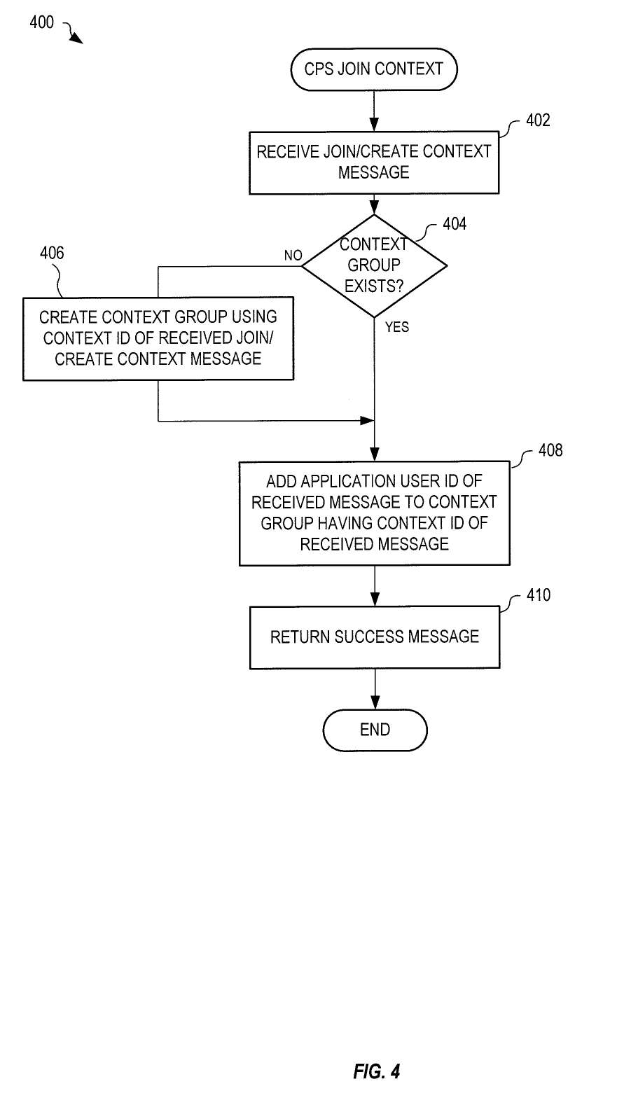

FIG. 4 is a flowchart illustrating one exemplary method 400 for processing a join message received from an application. Method 400 is implemented as machine readable instructions stored within a memory and executes by a processor within CPS 202, for example. In step 402, the CPS receives a join context message from an application. In one example of step 402, CPS 202 receives message 214 from application 206 running on user device 204(1). Step 404 is a decision. If, in step 404, the context group identified in step 402 exists, method 400 continues with step 408; otherwise, method 400 continues with step 406. In step 406, the CPS creates the context group using the context ID received in the join message of step 402. In one example of step 406, CPS 202 creates context group 220 based upon CPS application ID 208 and context ID 212 received in step 402. Method 410 continues with step 408.

In step 408, the application user ID received in step 402 is added as a member of the context group identified in step 402. In one example of step 408, CPS 202 adds application user ID 210(1), received in step 402, to context group 220 identified by context ID 212, also received in step 402. In step 410, the CPS returns a success message. In one example of step 410, CPS 202 returns message 222 to application 206 running on user device 204(1).

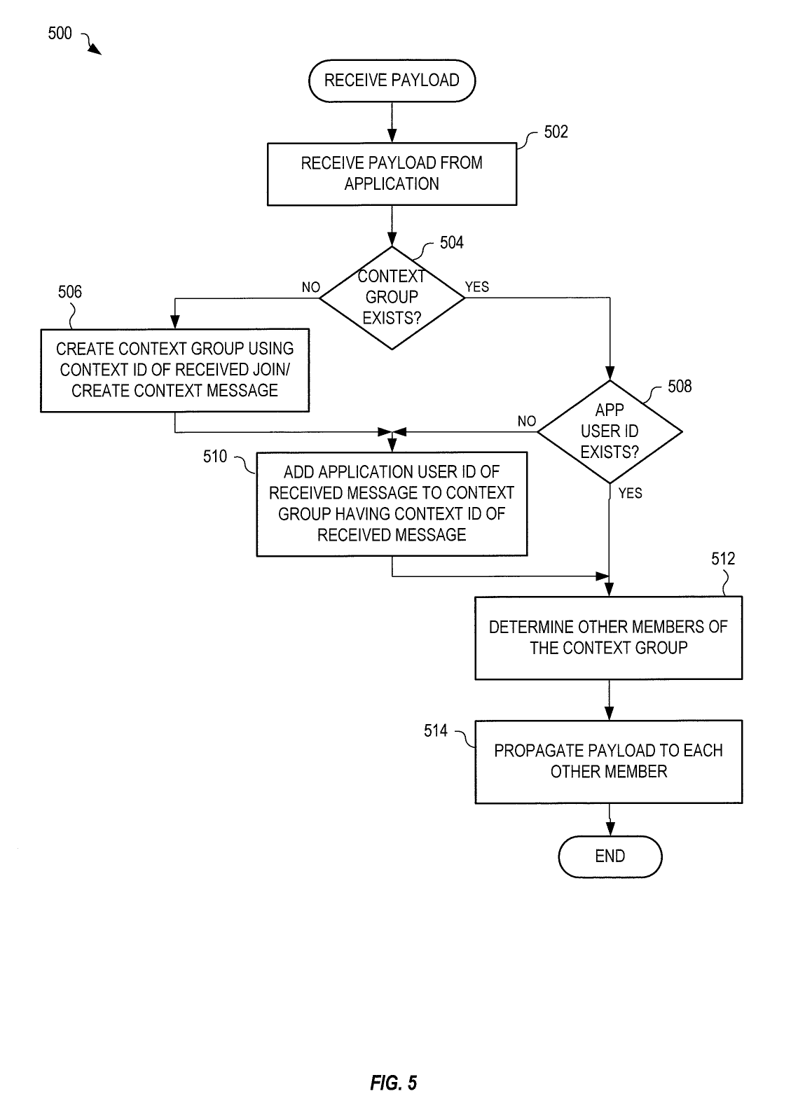

FIG. 5 is a flowchart illustrating one exemplary method 500 for processing a payload message. Method 500 is for example implemented as machine readable instructions stored within a memory and executed by a processor within payload handler 242 and CPS 202 of FIG. 2. In step 502, a payload is received from an application. In one example of step 502, payload handler 242 receives a payload message 232, containing application payload 230, from application 206 running on user device 204(1). Step 504 is a decision. If, in step 504, the context group identified in the received message of step 502 exists, method 500 continues with step 508; otherwise method 500 continues with step 506.

In step 506, a new context group is created using the context ID received in step 502. In one example of step 506, payload handler 242 interacts with context manager 240 to create context group 220 based upon context ID 212 received in payload message 232 at step 502. Method 500 continues with step 510.

Step 508 is a decision. If, in step 508, the application user ID received in step 502 exists within the context group, method 500 continues with step 512; otherwise, method 500 continues with step 510. In step 510, the application user ID, received in step 502, is added to the context group identified by the context ID also received in step 502. In one example of step 510, payload handler 242 interacts with context manager 240 to add application user ID 210 to context group 220. Method 500 continues with step 512.

In step 512, other members of the context group, identified by the context ID received in step 502, are determined. In one example of step 512, context manager 240 searches database 244 to identify application user IDs 210(1) and 210(2) within context group 220. In step 514, the payload is propagated to each other member. In one example of step 514, payload handler 242 propagates application payload 230 to application 206 of user device 204(2).

As used within CPS 202, identities are created and assigned by the applications interacting with the CPS, and not by the CPS. Thus, the CPS may operate with many different applications to create different context groups based upon the requirements of each application. Each application (e.g., application 206) wishing to utilize contextual services of CPS 202 has a unique CPS application ID 208. This unique CPS application ID is used together with the context ID 212 when creating context group 220 within CPS 202; the same context ID 212 may therefore be used with different applications without confusion.

Each context group created by CPS 202 operates to link individuals that may not otherwise be linked by presence. That is, these individuals may not be linked by conventional presence, and may not know one another, but they become linked within context group 220 and may thereby exchange payload data. Each application defines the content and size of the payload data, which is not evaluated or restricted by the CPS. The payload handler distributes a payload from a first member of a context group to all other members of that context group. In one embodiment, payload handler 242 implements a data size limit to prevent overwhelming system 200 with extremes of data. The number of context groups created by an application is not limited; an application may create as many context groups as necessary for its desired functionality. Where multiple instances of an application wish to share a single context group, each instance of the application uses the same context ID.

In one example of operation, a conferencing support application is used by a plurality of attendees of a conference. Each attendee utilizes the application to connect to a common context group, thereby allowing the attendees to share comments as payload data while at the conference. That is, comments entered to the conferencing support application are propagated to other members of the context group, thereby forming a “tweeting” type service specific to that conference, and between attendees (i.e. users of the conferencing support application) that are not necessarily otherwise connected by presence.

In another example, a customer relationship management (CRM) application may create a static context group (e.g., for a discussion room) that allows users (representatives and their customers) of the application to join the context group for discussion purposes. The application may also create a context group for an online customer meeting that provides a mechanism (through distribution of payload data) for communication, file transfer, and information sharing. In another similar example, a context group may be created for a group of employees attending the same conference. The users of the application are thereby automatically connected through the context group with other employees at the same conference without requiring complicated configuration and individual ID management.

Exemplary payload data defined by an application may include a user's phone number that allows other members of the context group to contact other members through the application and the context group. In one example, application 206 allows the user to place a call to another member of a context group without the user learning the phone number of the member or dialing it. That is, the application need not make all payload data available to users of the application.

A user may become a member of multiple context groups. A context group may exist with only one member. The use of context groups and their associated payload data is very flexible, and allows CPS 202 to provide contextual presence support for many different types of application. It should be noted that a context group provided by the CPS is not synonymous with conventional presence status. That is, different status of an end user should not be seen as being in a different context group. Rather, users that may have differing status are related when joining the same context group and may receive payload data distributed within that context group.

In another example, application 206 is a game played by many people on many different user devices. The payload data associated with the game includes statistics of the game based upon the uses performance. Application 206 may not reveal personal information included with received payload data from other players of the game, but may allow that information to be used within the application 206.

It should be noted that payload data (e.g., payload data 230) is delivered to members of a context group and is not processed by CPS 202. That is, neither CPS 202 nor payload handler 242 evaluate the content of the payload data.

FIG. 6 shows exemplary handling, by payload handler 242 of FIG. 2, of payload message 232. Payload handler 242 has a plurality of edge nodes 602 that form a network for propagating payload data 230 of payload message 232 from one member of a context group (e.g., context group 220, FIG. 2) to other members of that context group. In one embodiment, edge nodes 602 form a distributed network, wherein payload handler 242 is spatially distributed to facilitate payload propagation. That is, edge nodes 602 need not be co-located with CPS 202. For example, edge nodes 602 are geographically distributed.

Payload handler 242 also includes a payload manager 604 (that may be located within CPS 202) that maintains a routing table 606 within each edge node 602 based upon context group information stored within database 244. As shown in FIG. 6, edge node 602(1) has a routing table 606(1), edge node 602(2) has a routing table 606(2), and edge node 602(3) has a routing table 606(3). Routing tables 606 facilitate routing of payload message 232 between edge nodes 602, and to destination user devices 204 based upon an associated context. Using routine tables 606, edge nodes 602, upon receipt of payload message 232, each edge node 602 may quickly and efficiently propagate payload message 232 to other edge nodes and user devices, without requiring access to database 244 or other functionality of CPS 202. In one embodiment, user devices 204 form edge nodes of payload handler 242 and perform peer-to-peer communication with other user devices based upon context group 220.

To facilitate routing of payloads to user devices, each application user ID 210 added to context group 220 may also include connectivity information, such as web addresses, port addresses, etc. that facilitate propagation of application payload 230. In one embodiment, database 244 maintains connectivity information for each application user ID 210 within context group 220. Payload manager 604 generates and maintains routing tables 606 based upon this stored connectivity information.

In one example of operation, user device 204(1) sends payload message 232 to a first edge node 602(1) of payload handler 242. Edge node 602(1) utilizes routing table 606(1) to determine that payload message 232 is to be sent to edge nodes 602(2) and 602(3). Upon receiving payload message 232, edge node 602(2) utilizes routing table 606(2) to route payload message 232 to user device 204(2). Similarly, upon receiving payload message 232, edge node 602(3) utilizes routing table 606(3) to route payload message 232 to user device 204(3). Although only one user device 204 is shown connected to each edge node 602, edge nodes 602 may each connect to many user devices without departing from the scope hereof.

By utilizing a network (optionally a distributed network) of edge nodes 602, or a peer-to-peer network of user devices 204, propagation of payload message 232 avoids the typical bottle necks associated with conventional presence servers (wherein presence registration and propagation of presence updates are handled by the presence server), and thereby facilitating improved scalability of CPS 202. That is, since the internal components of CPS 202 handle context changes, and external components (e.g., edge nodes 602) handle payload data, scalability is improved over conventional presence.

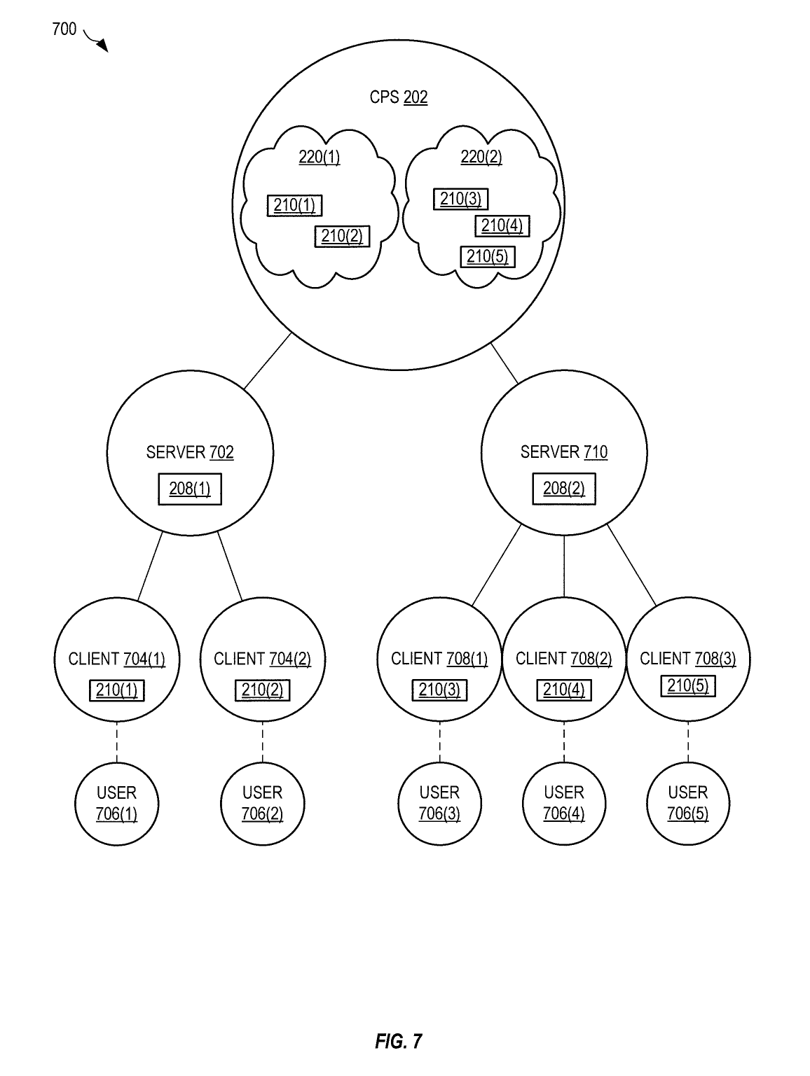

FIG. 7 shows CPS 202 connected to two application servers 702 and 710, each having a plurality of clients 704 and 708, respectively. Each client 704, 708 is shown with an associated user 706. Application server 702 has an assigned CPS application ID 208(1) and creates a context group 220(1) within CPS 202. Application sever 710 has a CPS application ID 208(2) and creates a context group 220(2) within CPS 202. Each application server 702, 710, may utilize more than one context group 220 within CPS 202.

In one embodiment, application server 702 assigns application user ID 210(1) to client 704(1), and application user ID 210(2) to client 704(2). Application server 702 may then add application user IDs 210(1) and 210(2) to context group 220(1), as shown, thereby automatically registering users 706(1) and 706(2) with context group 220(1). Users 706(1) and 706(2) need not be co-located, and need not know one another; however, through use of context group 220(1) by application server 702, users 706(1) and 706(2) become contextually aware of one another. Application server 702 may create more than one context group within CPS 202, such that users (e.g., users 706(1) and 706(2)) may be contextually linked in different ways, for example based upon selected options within client 704. In another embodiment, client 708(1) assigns application user ID 210(3) to user 706(3), for example based upon information of user 706(3), client 708(2) assigns application user ID 210(4) to user 706(4), for example based upon information of user 706(4), and client 708(3) assigns application user ID 210(5) to user 706(5), for example based upon information of user 706(5). Each client 708, via application server 710, adds its assigned application user ID 210 to context group 220(2), as shown in FIG. 7.

In one example of operation, application server 702 represents a customer relationship management tool, user 706(1) is a sales representative and user 706(2) is a customer accessing application server 702 via a client 704(2). Application server 702 creates context group 220(1) for a planned meeting (e.g., an online meeting) between the representative and the customer, thereby allowing specific data to be exchanged between the representative and the customer as payload data. For example, in preparation for a face-to-face meeting, the payload data may represent travel status and expected time of arrival data that is updated automatically by clients 704 that are mobile devices.

CPS 202 may simultaneously support many context groups 220 for many different applications.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A contextual presence system (CPS) for dynamically forming a context group having a plurality of members and for propagating payload data between the members, comprising:
a database for associating a context identifier (ID) of the context group with a user ID of each said member;
a context manager, communicatively coupled with the database, for:
receiving a join context request containing the context ID and a user ID from each said member;
creating the context group, if not existing, within the database in response to the join request; and
adding the user ID, if not existing, of each said member to the database in association with the context ID; and
a payload handler for receiving payload data from one of said members and for propagating the payload data to other said members of the context group.

2. The system of claim 1, wherein the CPS creates the context group in real-time upon receiving the join context request when the context ID does not exist within the database.

3. The system of claim 1, wherein the size and content of the payload data is defined by an application running on a user device that sent the join context request.

4. The system of claim 1, wherein the user ID is defined by an application running on a user device that sent the join context request.

5. The system of claim 1, wherein the context manager validates the join context request using a CPS application ID to identify an application sending the join context request.

6. The system of claim 1, wherein the context ID is generated by an application running on a user device that sent the join context request based upon a parameter under control of a user of the device.

7. The system of claim 6, wherein the user device may join more than one context group.

8. The system of claim 1, wherein the database further stores connectivity information of each of the user devices corresponding to said members of the context group.

9. The system of claim 1, wherein the payload handler is configured as a plurality of internetworked edge nodes in communication with the context manager, and wherein the payload data is received by a first edge node and propagated to at least one of the other said members via a second of the edge nodes without passing through a server of the context manager.

10. The system of claim 9, the payload handler further comprising a payload manager for storing, on each of the edge nodes, a routing table defining propagation of the payload data based upon connectivity of each said member of the context group.

11. The system of claim 9, wherein the edge nodes are geographically distributed.

12. A computer implemented method for dynamically forming a context group, comprising the steps of:
receiving, from a first user device running an application, a first join context request comprising (a) a context ID defined by the application and (b) a first user ID of the first user device; and
creating the context group within a database based upon the context ID and the first user ID directly upon receiving the first join context request.

13. The method of claim 12, further comprising the steps of:
receiving, from a second user device running a copy of the application, a second join context request comprising (c) the context ID and (d) a second user ID of the second user device; and
adding the second user ID to the context group by adding the second user ID to the database in association with the context ID.

14. The method of claim 13, wherein the steps of receiving the second join context request and adding are repeated for each received additional join context request.

15. The method of claim 13, further comprising the steps of:
receiving, from one of the first and second user devices, a payload message comprising (c) payload data, (d) the context ID, and (e) a corresponding one of the first and second user IDs; and
propagating the payload data to corresponding other of said first and second user devices based upon the context ID and the corresponding one of the first and second user IDs.

16. The method of claim 15, wherein the steps of receiving the payload data and propagating repeat for each additional payload message.

17. The method of claim 12, further comprising the steps of:
receiving, from one of the first and second user devices, a leave context message comprising the context ID and a corresponding one of the first and second user IDs; and
removing said corresponding one of the first and second user IDs from the context group;
wherein the context group is deleted from the database directly upon receiving the leave context message if the removed corresponding one of the first and second IDs was the only ID of the context group.
